(19) United States
(12) Patent Application Publication
(10) Pub. No.: US 2026/0105852 A1
(43) Pub. Date: Apr. 16, 2026

(54) SYSTEM TO MITIGATE EFFECTS TO VEHICLE SYSTEMS FROM FAULTY EXTERNAL DATA

(71) Applicant: Honeywell International Inc., Charlotte, NC (US)

(72) Inventors: Sreenivasan Govindillam K, Bangalore (IN); Kalimulla Khan, Bangalore (IN)

(73) Assignee: Honeywell International Inc., Charlotte, NC (US)

(21) Appl. No.: 19/076,550

(22) Filed: Mar. 11, 2025

(30) Foreign Application Priority Data
Oct. 15, 2024 (IN) 202411078132

(51) Int. Cl. G08G 5/50; H04W 4/44

(52) U.S. Cl. CPC G08G 5/50; H04W 4/44

(57) ABSTRACT

A system to mitigate effects of faulty external data provided to vehicle applications of vehicle systems is provided. The system includes a scenario manager with a memory and a processor. A database in the memory includes at least vehicle parameters. The processor is in communication with at least one external data source and the vehicle applications of the vehicle systems. The processor is configured to generate a list of valid insight options based on one or more of a vehicle travel mission, rules of travel, the vehicle parameters, and current vehicle state information. The processor is configured to communicate a strategy and the list of valid insight options to the external data source and forward on at least one of the valid insight options selected from the list of valid insight options by the external data source to at least one vehicle application.

### CROSS-REFERENCE TO RELATED APPLICATION

This application claims priority to Indian Provisional Patent Application No. 202411078132 filed on Oct. 15, 2024, the contents of which are incorporated herein by reference in their entirety.

### BACKGROUND

Aircraft avionic systems may communicate with external data sources over communication channels to gain information and processing resources. An example of an external data source is an electronic flight bag (EFB). An EFB provides a distributed computing mechanism in a cockpit of an aircraft that is not limited by memory and CPU constraints. Further, external applications in the EFB can provide fast and intensive computations to evaluate multiple scenarios and augmentation of data from multiple sources. Insights derived by an EFB may be sent to the avionic systems for review and acceptance to achieve a desired goal such as, but not limited to, mission efficiency (fuel, time or operational efficiencies) and safety.

While communications between the avionic systems and external data sources may enable efficiencies in the cockpit, the communications also introduce vulnerabilities that may be exploited by rogue agents set on compromising a mission of the aircraft. External applications that support communication with the avionic systems may be non-certified and any insights generated by the external applications may or may not be completely reliable. Pilots currently must be thorough in their review of external insights from such external applications before accepting them into the avionics systems. This review process can be cumbersome for the pilots and error prone due to lack of information on the impact of the insights on a flight mission.

For the reasons stated above and for other reasons stated below which will become apparent to those skilled in the art upon reading and understanding the present specification, there is a need in the art for an effective and efficient system to mitigate effects of external data on vehicle systems.

### SUMMARY

The following summary is made by way of example and not by way of limitation. It is merely provided to aid the reader in understanding some of the aspects of the subject matter described. Embodiments provide a system to mitigate effects of external data on vehicle systems.

In one embodiment, a system to mitigate effects of faulty external data provided to vehicle applications of vehicle systems is provided. The system includes a plurality of vehicle systems and a scenario manager. The plurality of vehicle systems includes a plurality of vehicle applications. The plurality of vehicle applications are configured to at least in part control operations of a vehicle. The scenario manager includes a memory and a processor. The memory stores operating instructions and at least one database. The at least one database includes at least vehicle information. The processor is configured to implement the operating instructions stored in the memory. The processor is in communication with an external data source and the plurality of vehicle applications of the plurality of the vehicle systems. The processor is configured to generate a list of valid insight options based at least in part on at least one of the vehicle information and travel information. The processor is configured to communicate a strategy and the list of valid insight options to the external data source. The processor further configured to forward on one of the valid insight options selected from the list of valid insight options by the external data source to at least one vehicle application of the plurality of vehicle applications of the plurality of vehicle systems.

In another embodiment, another system to mitigate effects of faulty external data provided to vehicle applications of vehicle systems is provided. The system includes a plurality of vehicle systems, a scenario manager and a gateway. The plurality of vehicle systems includes a plurality of vehicle applications, the plurality of vehicle applications are configured to at least in part control operations of a vehicle. The scenario manager includes a memory to store operating instructions and at least one database. The at least one database includes at least one of vehicle information and travel information. The processor is configured to implement the operating instruction stored in the memory. The processor is in communication with at least one external application of an external device and the plurality of vehicle applications of the vehicle. The processor further in communication with a bus to receive current vehicle state information. The processor is configured to generate a list of valid insight options based at least in part on at least one of the vehicle information and the travel information. The processor is configured to communicate a strategy and the list of valid insight options to at least one external application of an external device. The processor is further configured to forward on one of the valid insight options selected from the list of valid insight options by the external application to at least one vehicle application of the plurality of vehicle applications of the plurality of vehicle systems. The gateway is used to interface communications between the scenario manager and the external device.

In yet another embodiment, a method of mitigating effects of faulty external data provided to vehicle applications of vehicle systems is provided. The method includes generating at least one list of valid insight options; communicating a strategy and the at least one list of valid insight options to an external device, the external device configured to select at least one valid insight option of the at least one list; and forwarding the selected at least one valid insight option to at least one vehicle application of the vehicle systems for implementation.

### BRIEF DESCRIPTION OF THE DRAWINGS

The present invention can be more easily understood and further advantages and uses thereof will be more readily apparent, when considered in view of the detailed description and the following figures in which:

FIG. 1 is a block diagram of a vehicle that includes a system to mitigate effects of external data on vehicle systems according to an example aspect of the present invention;

FIG. 2A is a block diagram illustrating a system to mitigate effects of external data on vehicle systems by providing a list of valid insight options to an external data source in an aircraft example according to an example aspect of the present invention;

FIG. 2B is a block diagram illustrating an external data source providing selected valid insights from lists of valid insight options back to the system to mitigate effects of external data on vehicle systems in an aircraft example according to an example aspect of the present invention;

FIG. 3A illustrates a flow diagram of a best option selection strategy to mitigate effects of faulty external data according to an example aspect of the present invention;

FIG. 3B illustrates a flow diagram of a ranked option strategy to mitigate effects of faulty external data according to an example aspect of the present invention;

FIG. 3C illustrates a flow diagram of a selection of a number of best options to mitigate effects of faulty external data according to an example aspect of the present invention;

FIG. 4 illustrates a flow diagram of an option selection process according to an example aspect of the present invention;

FIG. 5A illustrates a flow diagram of a traffic avoidance process according to an example aspect of the present invention;

FIG. 5B illustrates a first traffic strategy according to an example aspect of the present invention;

FIG. 5C illustrates a second traffic strategy according to an example aspect of the present invention;

FIG. 5D illustrates a third traffic strategy according to an example aspect of the present invention;

FIG. 5E illustrates a fourth traffic strategy according to an example aspect of the present invention;

FIG. 5F illustrates a fifth traffic strategy according to an example aspect of the present invention;

FIG. 5G illustrates a sixth traffic strategy according to an example aspect of the present invention;

FIG. 5H illustrates a seventh traffic strategy according to an example aspect of the present invention;

FIG. 6A illustrates a flow diagram of a weather avoidance process according to an example aspect of the present invention;

FIG. 6B illustrates a first weather strategy according to an example aspect of the present invention;

FIG. 6C illustrates a second weather strategy according to an example aspect of the present invention;

FIG. 6D illustrates a third weather strategy according to an example aspect of the present invention;

FIG. 6E illustrates a fourth weather strategy according to an example aspect of the present invention;

FIG. 6F illustrates a fifth weather strategy according to an example aspect of the present invention;

FIG. 6G illustrates a sixth weather strategy according to an example aspect of the present invention;

FIG. 7A illustrates a flow diagram of a terrain avoidance process according to an example aspect of the present invention;

FIG. 7B illustrates a first terrain strategy according to an example aspect of the present invention;

FIG. 7C illustrates a second terrain strategy according to an example aspect of the present invention;

FIG. 7D illustrates a third terrain strategy according to an example aspect of the present invention;

FIG. 7E illustrates a fourth terrain strategy according to an example aspect of the present invention;

FIG. 7F illustrates a fifth terrain strategy according to an example aspect of the present invention;

FIG. 7G illustrates a sixth terrain strategy according to an example aspect of the present invention;

FIG. 7H illustrates a seventh terrain strategy according to an example aspect of the present invention;

FIG. 8A illustrates a flow diagram of a travel path safety process according to an example aspect of the present invention;

FIG. 8B illustrates a first safety strategy according to an example aspect of the present invention;

FIG. 8C illustrates a second safety strategy according to an example aspect of the present invention;

FIG. 8D illustrates a third safety strategy according to an example aspect of the present invention;

FIG. 8E illustrates a fourth safety strategy according to an example aspect of the present invention;

FIG. 8F illustrates a fifth safety strategy according to an example aspect of the present invention;

FIG. 8G illustrates a sixth safety strategy according to an example aspect of the present invention;

FIG. 8H illustrates a seventh safety strategy according to an example aspect of the present invention;

FIG. 9A illustrates a flow diagram of a runway selection process according to an example aspect of the present invention;

FIG. 9B illustrates a first runway strategy according to an example aspect of the present invention;

FIG. 9C illustrates a second runway strategy according to an example aspect of the present invention;

FIG. 9D illustrates a third runway strategy according to an example aspect of the present invention;

FIG. 9E illustrates a fourth runway strategy according to an example aspect of the present invention;

FIG. 9F illustrates a fifth runway strategy according to an example aspect of the present invention;

FIG. 9G illustrates a sixth runway strategy according to an example aspect of the present invention; and

FIG. 9H illustrates a seventh runway strategy according to an example aspect of the present invention.

In accordance with common practice, the various described features are not drawn to scale but are drawn to emphasize specific features relevant to the present invention. Reference characters denote like elements throughout Figures and text.

### DETAILED DESCRIPTION

In the following detailed description, reference is made to the accompanying drawings, which form a part hereof, and in which is shown by way of illustration specific embodiments in which the inventions may be practiced. These embodiments are described in sufficient detail to enable those skilled in the art to practice the invention, and it is to be understood that other embodiments may be utilized and that changes may be made without departing from the spirit and scope of the present invention. The following detailed description is, therefore, not to be taken in a limiting sense, and the scope of the present invention is defined only by the claims and equivalents thereof.

The terms “external data” sometimes referred to as “open world data” as used herein shall mean data that is generated outside of certified systems of a vehicle. In the context of avionic examples, external data may come from non-certified systems such as an electronic flight bag (EFB), an installed non-certified open world computer in the flight deck, a communication interface to a cloud application, etc. Further the terms “vehicle information” used herein shall include vehicle parameter information and current vehicle state information. In addition, the terms “travel information” shall include vehicle travel mission information and rules of travel information.

Embodiments of the present invention provide a system that ensures integrity of external data, sometimes called open world data, used by vehicle system applications by mitigating the effects of the external data. The system in examples includes a scenario manager that creates a list of valid insight options. The scenario manager includes a processor and a memory. The memory in an example, includes a database that may include vehicle information and travel information. The scenario manager is configured to generate a list of valid insight options and a strategy that is communicated to an external data source. The list may be generated in response to a request. The request may come from a vehicle operator, vehicle system, remote vehicle service station, etc. Based on the request and vehicle information and travel information, the scenario manager generate the list of valid insights options. Each option in the valid insight options provides a valid solution to the request. The list of the valid insight options and the strategy are then communicated to an external data source. The external data source uses its available resources to select at least one option (based on the strategy) in the list of valid insight options. The selected option is then communicated back to the scenario manager. The scenario manager then provides the selected option to system applications of vehicle systems for use. Since the selected option is already known to be valid (it was one of the valid options in the list of valid options) even if the external data source used corrupt applications or data in generating the selection of the option, application of the selected option in the vehicle will not have a devastating impact on the vehicle.

In an avionic application, the database may include aircraft and travel information including, but not limited to, rules of flight, aircraft parameters and aircraft mission parameters. Content of the database may be provided in one avionic example, by at least one avionic system of the aircraft. The scenario manager in an example is a certified system so that the valid insight options computed are applicable, safe, and secure for the vehicle. In an aircraft application, the scenario manager is in communication with avionic systems that may include a flight management system (FMS), an enhanced ground proximity warning system (EGPWS), a communication system, a navigation system, and a surveillance system, etc., and is in communication with the external data source through a connected channel.

As discussed above, the list of valid insight options along with a strategy is provided by the scenario manager to an external application of an external data source, such as, but not limited to, an electronic flight bag in an avionic application. The external data source is used to identify the most desirable valid insight option in the provided list of valid insight options based on the strategy provided to the external data source by the scenario manager. Examples of strategies in an avionic application include fuel efficiency during flight, shortest time of flight, shortest distance of flight, weather avoidance, traffic avoidance, etc. The external data source may use external data, external insights and additional computations to select the most desirable valid insight option from the list of valid insight options provided by the scenario manager using the strategy. The external data source then communicates the selected valid insight option to the scenario manager. As discussed above, since the selected valid insight option is one of the valid insight options in the list of valid insight options provided by the scenario manager, the selected valid insight option provided by the external application will have no adverse impact to the mission of the aircraft. Hence, even in a case of suspected external insight from a rogue agent, the insight option selected can only be from the list of valid insight options pre-computed by the scenario manager. Once the external application selects the valid insight option, the scenario manager forwards the selected valid insight option on to at least one application in at least one aircraft system for implementation. Although, the present invention provides examples of the scenario manager being use in avionic applications, the scenario manager and its functions may be used in other types of vehicles including vehicles that travel by land and water.

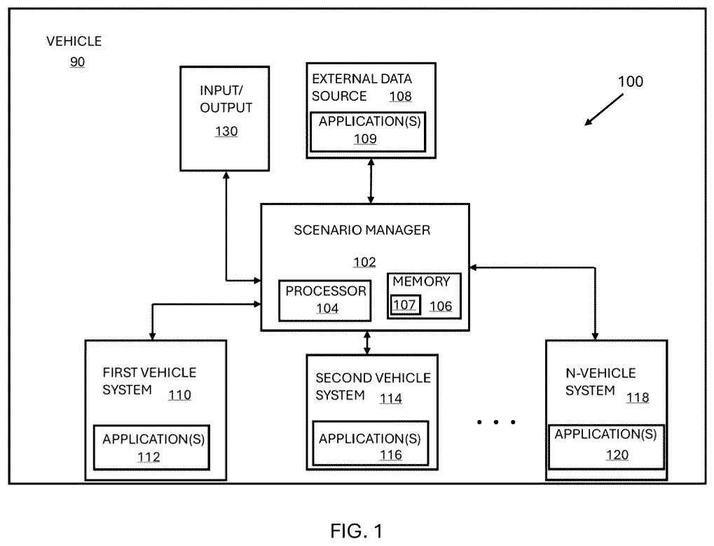

FIG. 1 illustrates a block diagram of a vehicle 90 that includes a system 100 to mitigate effects of faulty external data provided to vehicle applications of vehicle systems. System 100 includes a scenario manager 102. Scenario manager 102 includes a processor 104 and a memory 106. Memory 106, in one example, includes a database 107 that may include vehicle information and travel information that may be gathered from one or more of the vehicle systems. The vehicle systems in this example include a first vehicle system 110 with applications 112, a second vehicle system 114 with applications 116 and an N-vehicle system 118 with applications 120.

In general, processor 104 may include any one or more of a microprocessor, a digital signal processor (DSP), an application specific integrated circuit (ASIC), a field program gate array (FPGA), or equivalent discrete or integrated logic circuitry. In some example embodiments, processor 104 may include multiple components, such as any combination of one or more microprocessors, one or more controllers, one or more DSPs, one or more ASICs, one or more FPGAs, as well as other discrete or integrated logic circuitry. The functions attributed to processor 104 herein may be embodied as software, firmware, hardware or any combination thereof. Processor 104 may be part of a system controller or a component controller. For example, the processor may be part of a certified vehicle system such as, but not limited to, a flight management system in an avionic example. Memory 106 may include computer-readable operating instructions that, when executed by processor 104 provides functions of system 100 to mitigate effects of faulty external data provided to vehicle applications of vehicle systems. Such functions may include the functions of generating the list of valid insight options described below. The computer readable instructions may be encoded within the memory. Memory 106 is an appropriate non-transitory storage medium or media including any volatile, nonvolatile, magnetic, optical, or electrical media, such as, but not limited to, a random access memory (RAM), read-only memory (ROM), non-volatile RAM (NVRAM), electrically-erasable programmable ROM (EEPROM), flash memory, or any other storage medium.

An external data source 108 is in communication with scenario manager 102. External data source 108 includes external applications 109 used to generate information useful to the vehicle systems. As discussed above, an external data source, such as external data source 108 may provide external data, external insights and computation resources that may be used by the vehicle systems. The external data source 108 may be a non-certified open world computer or a communication interface to a cloud application. Further in avionic examples, the external data source 108 may be an electronic flight bag, an installed non-certified open world computer in a flight deck, a communication interface to a cloud application, etc.

An input/output 130 is also in communication with scenario manager 102 in the example of FIG. 1. The input/output 130 may include a display and an input device. The scenario manager 102 in an example, may cause the display to convey a list of valid insight options generated by the scenario manager 102 and the insight options selected by the external data source 108. In one example, the input device allows an operator of the vehicle 90 to selectively approve and allow the selected insight options to be forwarded to the applications of the vehicle systems, such as applications 112 of the first vehicle system 110, applications 116 of the second vehicle system 114, and application 120 of the N-vehicle system. In other examples, once the insight options are selected by the external data source 108, the selected insight options are automatically forwarded on to the applications of associated vehicle systems.

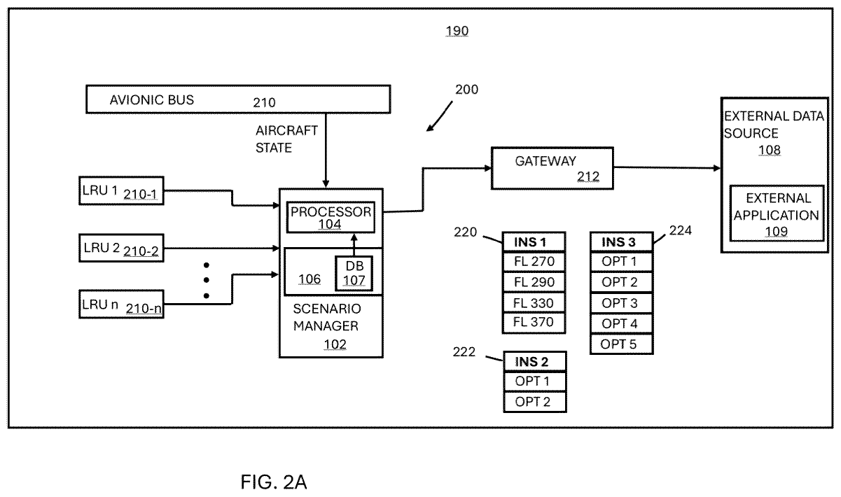

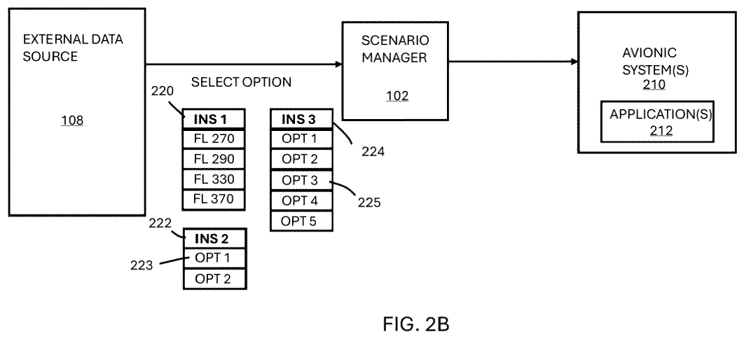

FIG. 2A illustrates an example of the generating and providing of valid insight options to an external data source 108 with a system 200 to mitigate effects of faulty external data provided to vehicle applications of vehicle systems in an avionic system. The processor 104 of the scenario manager 102 is in communication with an avionic bus 210 to receive aircraft state information. Processor 104 is also in communication with line replaceable units (LRUs) that provide information relating to rules of travel, vehicle parameters, and mission parameters. The LRU's in this example, includes a first LRU 210-1, a second LRU 210-2 and a N-LRU 210-n. The LRUs may include the vehicle systems such as a flight management system (FMS), an enhanced ground proximity warning system (EGPWS), a communication system, a navigation system, a traffic alert and collision avoidance system (TCAS) and a surveillance (CNS) system.

Processor 104 generates a list of the valid insight options based on operating instructions stored in memory 106, information gathered from the avionic bus 210 and the LRUs 210-1 through 210-n. The list of valid insight options, as well as a strategy, is provided to external data source 108 through a gateway 212 in this example. Gateway 212 provides an interface of communications between the scenario manager 102 and the external data source 108 in this example. Examples of valid insights options in an avionic application include flight level, speed, cost index, control switches, settings etc. The scenario manager 102 may generate the list of valid insight options using vehicle information and travel information.

The list of valid insight options provided to external data source 108 along with a strategy includes in this example, a first insight (INS) list 220, a second insight list 222, and a third insight list 224. The first insight list 220 of insights relates to valid flight levels (FLs), i.e., FL330, FL370, FL290, FL270. Only valid insights that are applicable in a then current context are provided to the external data source 108.

For example, for an aircraft 190 at a FL310 that is travelling east bound, the scenario manager 102 can dynamically compute a set of valid insights options (flight levels FL330, FL370, FL290, FL270) based on the current aircraft state that is obtained from avionic bus 210 that are safe and efficient for the mission. The list of valid insight options may be generated with reference to the mission parameters such as, since the route is east bound, the FL must be in an odd thousands of feet, a maximum altitude of FL380 must not be exceeded based on a load factor, a temporary flight restriction at FL350 is in place, and any flight level below FL270 will burn excessive fuel.

Once the valid insight options are sent to external data source 108, an eternal application 109 of the external data source 108 evaluates data available to the external data source 108, such as but not limited to, wind conditions at each of these flight levels, verifies any traffic congestion at the flight levels and then selects one of the four valid insight options for the cockpit for an efficient flight. This way, the insights are restricted to only the safe insight options and will never compromise the flight mission. Due to the inherent safety of insights with this mechanism, the need for pilot review is limited.

FIG. 2B illustrates external data source 108 has selected FL330 from the first insight list 220, the first option (OPT) 223 from the second insight list, and the third option 225 from the third insight list 224. The selection of the valid options by external data source 108 may be based on the strategy provided by the scenario manager, trajectory computations, a particular mode setting, a speed schedule etc. The external application(s) 109 runs through the options in the lists of valid insight to choose the most appropriate one and send it back to the scenario manager 102 for review and acceptance for use in the vehicle systems.

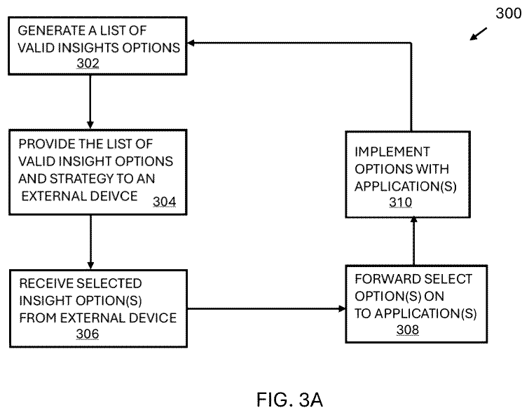

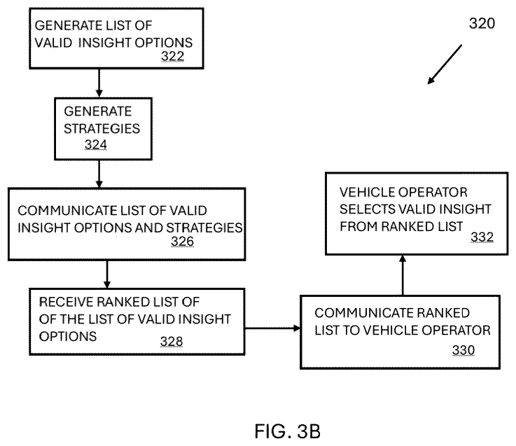

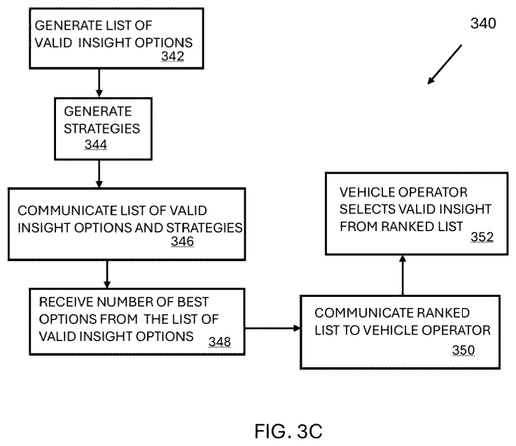

A method of an operating system to mitigate effects of faulty external data provided to vehicle applications of vehicle systems is illustrated in the flow diagrams of FIG. 3A through 3C. The flow diagrams in FIGS. 3A through 3C are provided as series of sequential blocks. The sequence of blocks may occur in a different order or even in parallel in other embodiments. Hence, the present invention is not limited to the sequential sequence set out in FIGS. 3A through 3C.

In FIG. 3A, a flow diagram 300 of a best option selection strategy to mitigate effects of faulty external data is illustrated. The example flow diagram 300 starts at block 302 where the scenario manager 102 generates at least one list of valid insight options. The valid insight options may be based on one or more of travel information such as a vehicle travel mission and rules of travel and vehicle information such as vehicle parameters and current vehicle state information. The list of the valid insight options and a strategy is provided to an external device at block 304. Examples of strategies that may be used include, but are not limited to, fuel efficiency during flight, shortest time of flight, shortest distance of flight, route to avoid traffic, route to avoid weather, etc. One or more applications in the external data source, using the defined strategy selects an option from the list of valid insight options. In an example, at least some of travel information and vehicle information may be provided in the strategy to the external data source 108.

At block 306, the selected insight option is received from the external data source 108. The scenario manager 102 then forwards the selected option on to one or more vehicle applications at block 308. In one example, an option is provided to an operator of the vehicle to except the selected insight option. One or more vehicle applications of the vehicle systems then implement the select insight option at block 310. The process then continues at block 302 generating a list of valid insight options as an associated vehicle travels along its assigned travel path in one example.

Another example of a method of processing information related to a list of valid insight options by an external data source is provided in flow diagram 320 of FIG. 3B. Flow diagram 300 provides a ranked option strategy to mitigate effects of faulty external data. At block 322, a list of valid insight options is generated by the scenario manager 102. As discussed above the scenario manager 102 generates the list of valid insight options with certified vehicle systems. The scenario manager 102 then generates strategies at block 324. As also discussed above, the strategies detail what the external data source 108 should consider when processing information relating to the valid insight options. The strategies in this example also include directions to rank the valid insight options provided by the scenario manager 102.

The list of valid insight options is communicated to the external data source at block 326. The external data source 108 then uses the information in the strategies and the external data source 108 resources to rank the options in the list of valid insight options. The scenario manager 102 receives a ranked list from the list of valid insight options at block 328. The scenario manager 102, in this example communicates the ranked list to a vehicle operator at block 330. In one example, scenario manager 102 conveys the ranked list to the vehicle operator, such as a pilot in an avionic example, in a display of the input/output 130. The vehicle operator then selects an option from the ranked list to be used by applications of vehicle systems to at least in part control operations of the vehicle at block 332.

In still another example of a method of processing information related to a list of valid insight options by an external data source using a number of best options strategy is illustrated in flow diagram 340 of FIG. 3C. At block 342 of flow diagram 340, a list of valid insight options is generated by the scenario manager 102. As discussed above, the scenario manager 102 generates the list of valid insight options with certified vehicle systems. The scenario manager 102 then generates strategies at block 344. As also discussed above, the strategies detail what the external data source 108 should consider when processing information relating to the valid insight options. The strategies may include vehicle parameters. The strategies in this example also include directions to rank the valid insight options.

The list of valid insight options is communication to the external data source at block 346. The external data source 108 then uses the strategy and the external data source 108 resources to select a desired number of best options in the list of valid insight options. For example, the strategy may include instructions to select the best two options from the list of valid options using the provided strategy. The scenario manager 102 receives the number of best options from the list of valid insight options at block 348. The scenario manager 102, in this example communicates the best options to a vehicle operator at block 350. In one example, scenario manager 102 conveys the best options to the vehicle operator, such as a pilot in an avionic example, in a display of the input/output 130. The vehicle operator then selects an option from the best options provided by the external data source 108 to be used by applications of vehicle systems to at least in part control operations of the vehicle at block 352.

Accordingly, a strategy provided to the external data source 108 may include selecting options based on a best option system that selects a best option from the list of insight options, a weighted system that provides different values to different strategies in selecting at least one option of the valid insight options, a ranking system that ranks the valid insight options, and a best select number of valid insight option system that provide a number of best options from the list of valid insight options.

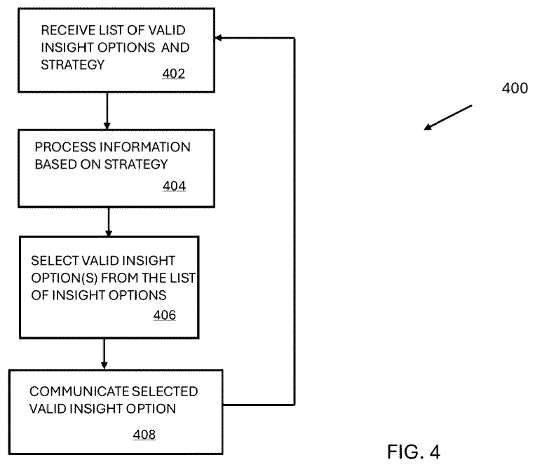

A method of processing information related to a list of valid insight options by an external device is illustrated in flow diagram 400 of FIG. 4. Flow diagram 400 provides an option selection as series of sequential blocks. The sequence of blocks may occur in a different order or even in parallel in other embodiments. Hence, the present invention is not limited to the sequence set out in FIG. 4.

Flow diagram 400 starts at block 402 where the external data source 108 receives a list of valid insight options and a strategy from the scenario manager 102. The strategy may include a description of the valid insight options (i.e., what the valid insight options relate to), instructions on what is to be considered in selecting a valid insight option from the list of valid insight options, vehicle information such as vehicle operating parameters and current vehicle state information and travel information such as travel mission and rules of travel. The external data source 108 in an avionic application may include an electronic flight bag or another system with resources to implement the strategy to select a valid insight option from the list of valid insight options.

The external data source 108 processes information based on the strategy provided by the scenario manager 102 at block 404. As discussed above, the resources available to external data source 108 may include processing resources as well as additional information access. The processing resources may be used to provide trajectory computations. Information available to the external data source 108 (external device) may include weather information, traffic information, vehicle operating characteristics as well as the information provided to the external data source 108 by the scenario manager such as mode settings and speed scheduling.

The external data source 108 at block 406 selects a valid insight option from the list of valid insight options. The external data source 108 selects the valid insight option by implementing one or more external device applications that use the information available and processing available to the external data source 108. Since the external data source 108 is directed to only select one or more of the valid insight options from the list of valid insight options, information used by the external data source 108 that is not valid in generating the selection, which may result in not choosing an optimal insight option, will have limited impact on vehicle systems, and operation of the vehicle, since the chosen insight option will also be a valid insight option.

The selected valid insight option is communicated to the scenario manager 102 at block 408. As discussed above in the method to mitigate effects of faulty external data in regard to flow diagram 300, the scenario manager 102 then forwards on the selected valid insight option on for use by vehicle systems. The process then continues at block 402 when another list of valid insight options and a strategy is received at the scenario manager 102. The process may continue as an associated vehicle is getting prepared to travel through a travel path and while the vehicle is traversing through the travel path.

In summary, embodiments use the resources of an internal vehicle device, such as a scenario manager, and information available to the scenario manager to generate a list of valid insight options when the vehicle needs or desires to make a change in vehicle operation. An external data source 108 with more resources, which may include more processing capability and more information access capability, is used to select one valid insight option from the list of valid insight options.

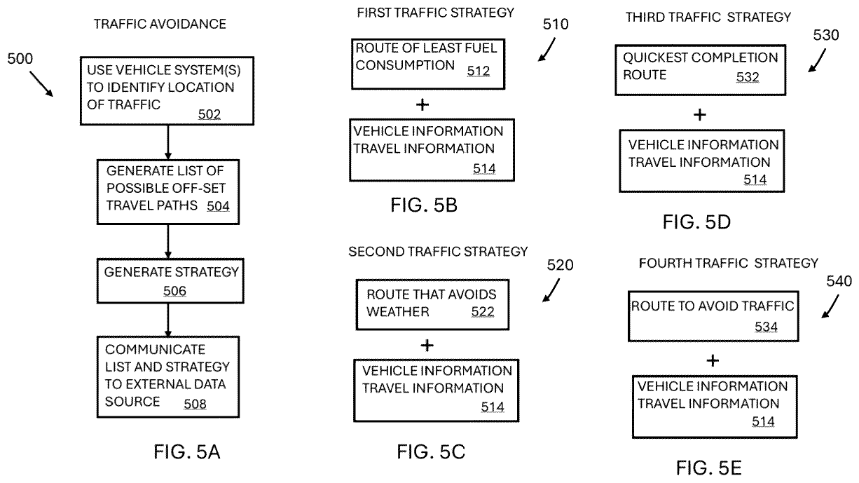

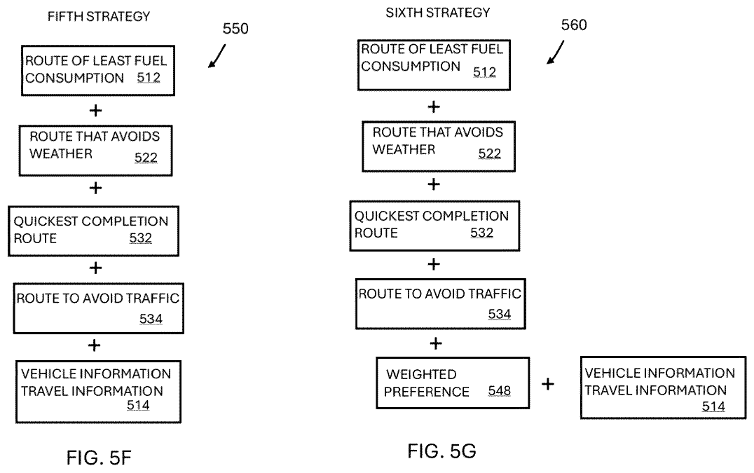

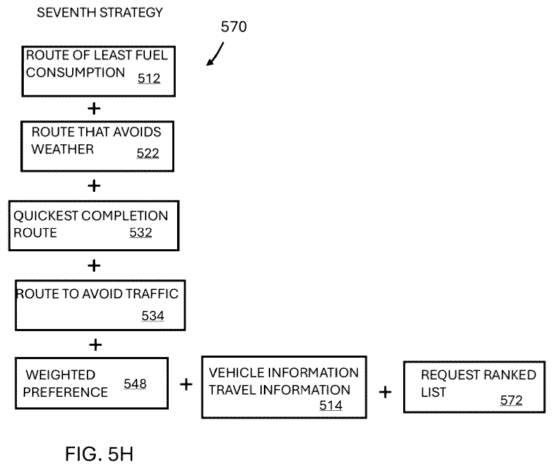

A method of traffic avoidance using a system to mitigate effects of faulty external data is provided in flow diagram 500 of FIG. 5A. Flow diagram 500 provides a traffic avoidance process in a sequence of blocks. The sequence of blocks may occur in a different order or in parallel in other embodiments. Hence, the present invention is not limited to the sequential sequence set out in FIG. 5A.

Flow diagram 500 begins at block 502, using vehicle systems to identify the location of traffic. Examples of a vehicle system to detect traffic includes a traffic alert and collision avoidance system, a surveillance system and a radar system. Once traffic is identified, a list of possible off-set travel paths (valid insight options) is generated by the scenario manager 102 at block 504. The list of off-set travel paths are travel paths that avoid the traffic detected at block 502.

The scenario manager 102 also generates a strategy at block 506. The strategy provides the external data source 108 information to be used in selecting an option from the list of off-set travel paths. The list of possible off-set travel paths and strategy are provided to the external data source 108 at block 508. As discussed above, a gateway 212 may be used to interface communications between the scenario manager 102 and the external data source 108. This may occur when the scenario manager 102 and the external data source 108 use different communication formats.

Example strategies associated with traffic avoidance is illustrated in FIGS. 5B through 5G. In this example, a new path is desired to avoid traffic. The scenario manager 102 creates a list of valid insight options (i.e., list of valid off-set travel paths that avoid traffic). Other factors, besides avoiding traffic, may also be considered by the external data source 108 in selecting one or more valid insight options from the list of valid insight options using the strategy provided with the list of valid insight options. Strategies provided in FIGS. 5B through 5G are examples of possible strategies that could be used in the traffic avoidance example. Each strategy discussed in FIGS. 5B through 5G may also include vehicle information and travel information 514 (such as current vehicle state, vehicle parameters, travel mission and rules of travel) to provide external data source 108 base information to be used by the resources of the external data source 108 in selecting at least one option from the list of valid insight options. The vehicle parameters may include performance information, such as a maximum altitude, maximum speed, stall speed, etc., from a performance database.

The first traffic strategy 510 of FIG. 5B provides the external data source 108 directions to select travel path from among the list of off-set travel paths. The first strategy example directs the external data source 108 to select the best travel path that provides the least fuel consumption among the valid insight options (valid off-set travel paths). This may be used in a situation where the current amount of fuel in the vehicle is limited so the conservation of fuel is paramount in completing a vehicle's mission (i.e., reaching a designated runway in an avionic example). In another example, scenario manager 102, besides considering traffic avoidance, may also consider fuel consumption information from vehicle systems in generating the list of possible valid off-set travel paths. In an aircraft example, this may be done with a flight management system.

FIG. 5C illustrates an example of a second traffic strategy 520 relating to traffic avoidance that includes a route that also avoids weather 522. The strategy directs the external data source 108 to select the best travel path that avoids undesirable weather among the valid insight options (provided list of possible valid off-set travel paths). This strategy may be used when the potential of undesired weather is present that could be encountered in one or more the valid off-set travel paths. In one example, scenario manager 102, besides considering traffic avoidance in generating the valid off-set travel paths, also considers weather information from available vehicle systems. In this example, the scenario manager 102, may look at available resources within systems of the vehicle, including an aircraft weather radar as well as from other certified sources in generating the list of verified insight options sent to the external data source 108.

FIG. 5D illustrates an example of a third traffic strategy 530 relating to traffic avoidance that includes a quickest completion route 532. The strategy directs the external data source 108 to select the best travel path for completing the vehicle's mission in the shortest time from the provided list of possible valid off-set travel paths. This strategy may be used when it is desired to reach the end of a mission as fast as possible. This may be desired with the vehicle is behind schedule. In one example, scenario manager 102, besides considering traffic in generating the valid insight options, also determines off-set travel paths with quickest completion times for the list of valid insight options. The scenario manager 102, in this example, may look at available travel route processing applications within systems of the vehicle. One example system is a flight management system. Further in a traffic strategy, a shortest route may be used.

FIG. 5E illustrates an example of a fourth traffic strategy 540 relating to traffic avoidance that includes a request for a route to avoid traffic 534. The strategy directs the external data source 108 to use the resources of the external data source 108 to select the best travel path to avoid traffic from the list of valid off-set travel paths provided by the scenario manager 102. This strategy may be used when it is desired to use additional resources available to the external data source 108 in selecting a best valid off-set travel path to avoid traffic.

The strategy may include the consideration of several strategies as illustrated in the fifth traffic strategy 550 of FIG. 5F. In this example, the strategies provided to the external data source 108 include the route of least fuel consumption 512, the route that avoids weather 522, the quickest completion route 532, and the route to avoid traffic 534. The external data source 108 is directed to select a valid offset travel path from the list of valid insight options using all of these strategies plus the vehicle information and travel information 514.

With an embodiment that provides several strategies, a further strategy regarding a weighted preference may be used. An example of this is illustrated in the sixth traffic strategy 560 of FIG. 5G. In this example, the strategies provided to the external data source 108 include a route of least fuel consumption 512, a route that avoids weather 522, a quickest completion route 532, and a route to avoid traffic 534. The strategy also includes a weighted preference 548 that assigns different values to the different strategies for the external data source 108 to apply when selecting one of the valid insight options from the list of insight options. For example, a result of the route to avoid traffic 534 strategy may have a higher value than the quickest completing route 532 strategy in an example.

Instead of requesting one valid insight be selected from the list of valid insight options, a strategy may request the list of valid insights to be ranked. An example of this strategy is illustrated in the seventh traffic strategy 570 of FIG. 5H. In this example, the strategies provided to the external data source 108 include a route of least fuel consumption 512, a route that avoids weather 522, a quickest completion route 532, and a route to avoid traffic 534 plus vehicle information and travel information 514. A weighted preference 548 may also be used in this example to provide different values to the different strategies for the external data source 108. The strategy provides a request for a ranked list 572 of the valid insight options (valid off-set travel paths) to the external data source 108. In response, the external data source 108 provides a ranked list from which a vehicle operator can select from. Further in an example, only one strategy needs to be applied to provide a ranked list from the list of valid insight options. The external data source 108 in this example, merely ranks the valid insight options based on the strategy provided. Hence, embodiments can provide a ranked list based on one or more strategies.

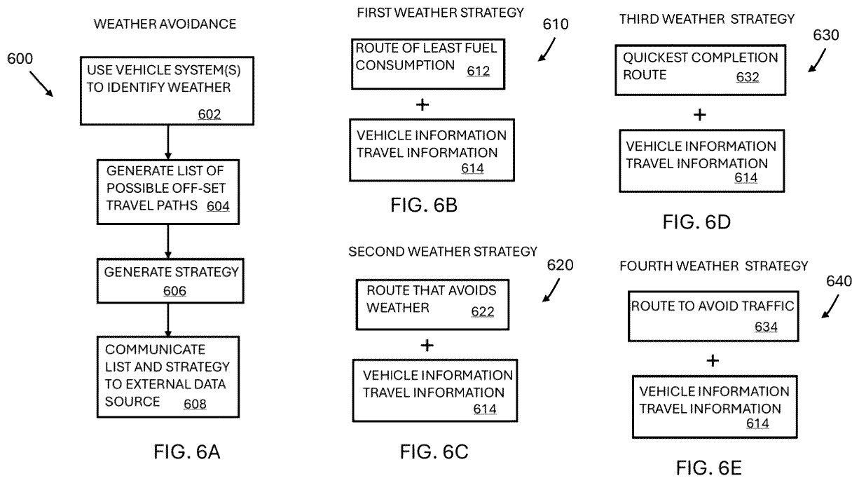

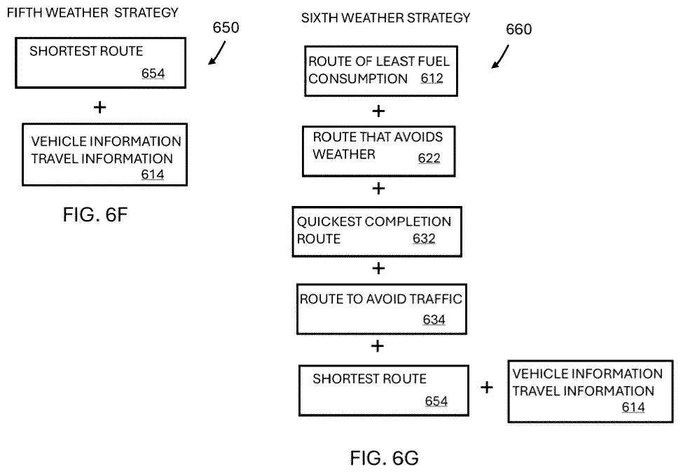

A method of weather avoidance using a system to mitigate effects of faulty external data is provided in flow diagram 600 of FIG. 6A. Flow diagram 600 illustrates a weather avoidance process in a sequence of blocks. The sequence of blocks may occur in a different order or in parallel in other embodiments. Hence, the present invention is not limited to the sequential sequence set out in FIG. 6A.

Flow diagram 600 begins at block 602, using vehicle systems to identify the location of weather that would be desired to be avoided. The vehicle systems may include an aircraft weather radar as well as from other certified weather generating systems. Once undesired weather has been identified, a list of possible off-set travel paths (valid insight options) is generated by the scenario manager 102 at block 604. The list of off-set travel paths are travel paths that avoid the identified undesirable weather.

The scenario manager 102 generates a strategy at block 606. The strategy provides the external data source 108 information to be used in selecting an option from the list of off-set travel paths. The list of possible off-set travel paths and at least one strategy are provided to the external data source 108 at block 608.

Examples of undesirable weather avoidance strategies are illustrated in FIGS. 6B through 6G. Each of the strategies discussed in FIGS. 6B through 6G may also include vehicle information and travel information 614. Examples of vehicle information may include performance information, such as a maximum altitude, maximum speed, stall speed, etc., from a performance database. Other factors, besides avoiding weather, may also be considered by the external data source 108 in selecting one or more valid insight options from the list of valid insight options using the strategy provided with the list of valid insight options.

An example of a first weather strategy 610 includes an additional strategy of a route of least fuel consumption 612. This first weather strategy 610 provides the external data source 108 directions to select a travel path from among the list of off-set travel paths based on a strategy of a rout of least fuel consumption 612. The strategy directs the external data source 108 to select the best travel path that provides the least fuel consumption among the valid insight options (provided list of possible valid off-set travel paths). This may be used in a situation where the current amount of fuel in the vehicle is limited so the conservation of fuel is paramount in completing a vehicle's mission (i.e., reaching a designated runway in an avionic example). In another example, scenario manager 102, besides considering weather avoidance, may also consider fuel consumption information from vehicle systems in generating the list of possible valid off-set travel paths that avoid the undesirable weather. In an aircraft example, this may be done with a flight management system.

FIG. 6C illustrates an example of a second weather strategy 620 relating to weather avoidance that also directs the external data source to use the strategy of selecting a route that avoids weather 622. The strategy directs the external data source 108 to select the best travel path that avoids undesired weather among the valid insight options (provided list of possible valid off-set travel paths). This strategy may be used when it is desired to use additional weather resources available from the external data source 108 in selecting a valid off-set travel path.

FIG. 6D illustrates an example of a third weather strategy 630 relating to weather avoidance that includes a quickest completion route 632. The strategy directs the external data source 108 to select the best travel path for completing the vehicles mission in the shortest time from the provided list of possible valid off-set travel paths. This strategy may be used when it is desired to reach the end of a mission as fast as possible (i.e., in an aircraft application when the aircraft is behind schedule). In one example, scenario manager 102 besides considering weather in generating the valid insight options, also determines off-set travel paths with quickest completion times for the list of valid insight options. The scenario manager 102, in this example, may look at available travel route processing applications within systems of the vehicle. One example system is a flight management system.

FIG. 6E illustrates an example of a fourth weather strategy 640 relating to weather avoidance that includes a request for a route to avoid traffic 634. The strategy directs the external data source 108 to use the resources of the external data source 108 to select the best travel path to avoid traffic from the list of valid off-set travel paths provided by the scenario manager 102. In one example, scenario manager 102 besides considering weather in generating the valid insight options, also determines traffic in generating the list of valid off-set travel paths. Examples of a vehicle system to detect traffic that may be used by the scenario manager includes a traffic alert and collision avoidance system, a surveillance system and a radar system.

FIG. 6F illustrates an example of a fifth weather strategy 650 relating to weather avoidance that includes a request for a shortest route 654. The strategy directs the external data source 108 to use the resources of the external data source 108 to select a travel path from the valid off-set travel paths provided by the scenario manager 102 as the shortest route. The scenario manager 102 may include a location of the vehicle with current vehicle parameters provided to the external data source 108.

The strategy may include the consideration of several strategies as illustrated in the sixth traffic strategy 660 of FIG. 6G. In this example, the strategies provided to the external data source 108 include the route of least fuel consumption 612, the route that avoids weather 622, the quickest completion route 632, the route to avoid traffic 634, and the shortest route 654. The external data source 108 is directed to select a valid offset travel path from the list of valid insight options using the strategy. Further, just as described above regarding the traffic strategies, the strategies to avoid weather may include a strategy request to provide a ranked list from the valid insight options (the off-set travel paths in this example). Also, the strategies may include a strategy request to provide a number of best valid insight options. Further, the strategies may include a strategy to assign weighted values to different strategies.

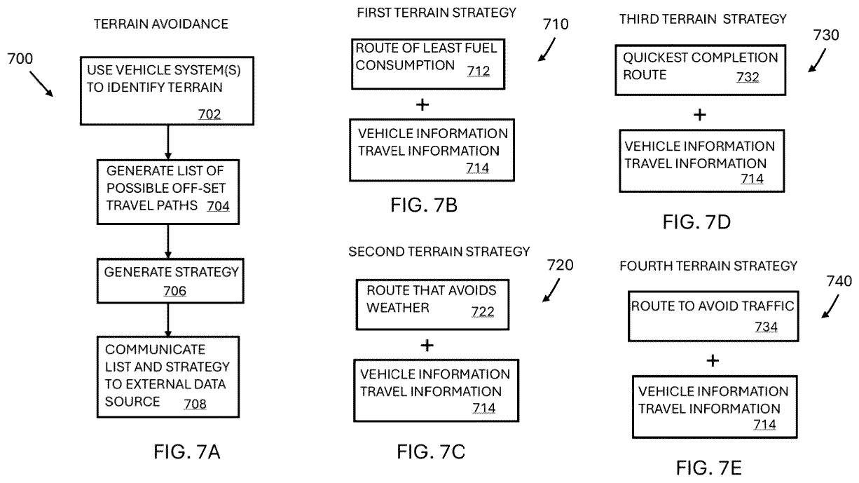

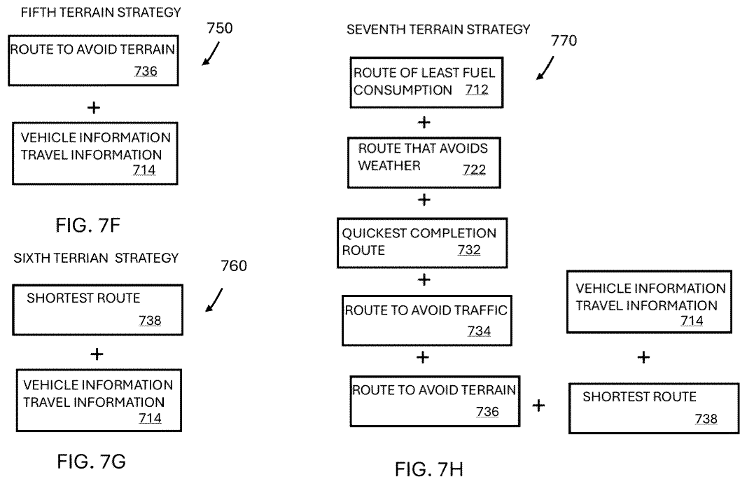

A method of terrain avoidance using a system to mitigate effects of faulty external data is provided in a flow diagram 700 of FIG. 7A. Flow diagram 700 includes a terrain avoidance process that is provided as a sequence of blocks. The sequence of blocks may occur in a different order or in parallel in other embodiments. Hence, the present invention is not limited to the sequential sequence set out in FIG. 7A.

Flow diagram 700 begins at block 702, using vehicle systems to identify travel paths that avoid terrain. The vehicle systems that may provide information to the scenario manager 102 in generating the list of valid insight options (valid off-set travel paths) include an enhanced ground proximity warning system, a ranging system including a light detecting and ranging system, global positioning systems, inertial measurements system, a terrain database, etc. Once undesired weather has been identified, a list of possible off-set travel paths (valid insight options) is generated by the scenario manager 102 at block 704. The list of off-set travel paths are travel paths that avoid the identified terrain to avoid.

The scenario manager 102 generates a strategy at block 706. The strategy provides the external data source 108 information to be used in selecting an option from the list of off-set travel paths. The list of possible off-set travel paths and strategy are provided to the external data source 108 at block 708.

Example terrain avoidance strategies are illustrated in FIGS. 7B through 7H. Each of the strategies discussed in FIGS. 7B through 7H also includes vehicle information and travel information 714. Other factors, besides terrain avoiding avoidance, may also be considered by the external data source 108 in selecting one or more valid insight options from the list of valid insight options using the strategy provided with the list of valid insight options.

In FIG. 7B, an example of a first terrain strategy 710 is provided that includes a terrain avoidance strategy with a strategy of a route of least fuel consumption 712. External data source 108 may use the operating parameters of the vehicle from vehicle information, provided in the strategy, in selecting one of the valid insight options from the list of valid insight options. Examples of parameters may include performance information, such as a maximum altitude, maximum speed, stall speed, etc., from a performance database.

The first terrain strategy 710 provides the external data source 108 directions to select a travel path from among the list of off-set travel paths based on the strategy. The strategy directs the external data source 108 to select the best travel path that provides the least fuel consumption among the valid insight options (provided list of possible valid off-set travel paths). This may be used in a situation where the current amount of fuel in the vehicle is limited so the conservation of fuel is paramount in completing a vehicle's mission (i.e., reaching a designated runway in an avionic example). In another example, scenario manager 102, besides considering terrain avoidance, may also consider fuel consumption information from vehicle systems in generating the list of possible valid off-set travel paths. In an aircraft example, this may be done with a flight management system.

FIG. 7C illustrates an example of a second terrain strategy 720 that directs the external data source to use the strategy of selecting a travel route that avoids weather 722. The strategy directs the external data source 108 to select the best travel path that avoids undesirable weather among the valid insight options (provided list of possible valid off-set travel paths). This strategy may be used when the potential of undesired weather is present that could be encountered in one or more the valid off-set travel paths. In one example, scenario manager 102 in generating the valid off-set travel paths, also considers weather information from available vehicle systems. In this example, the scenario manager 102, may look at available resources within systems of the vehicle, including an aircraft weather radar as well as from other certified sources in generating the list of verified insight options

FIG. 7D illustrates an example of a third terrain strategy 730 relating to terrain avoidance that includes a quickest completion route 732. The strategy directs the external data source 108 to select the best travel path for completing the vehicles mission in the shortest time from the provided list of possible valid off-set travel paths. This strategy may be used when it is desired to reach the end of a mission as fast as possible (i.e., in an aircraft application when the aircraft is behind schedule). In one example, scenario manager 102 besides considering terrain avoidance in generating the valid insight options, also determines off-set travel paths with quickest completion times for the list of valid insight options. The scenario manager 102, in this example, may look at available travel route processing applications within systems of the vehicle. One example system is a flight management system.

FIG. 7E illustrates an example of a fourth terrain strategy 740 relating to terrain avoidance that includes a request for a route to avoid traffic 734. The strategy directs the external data source 108 to use the resources of the external data source 108 to select the best travel path to avoid traffic from the list of valid off-set travel paths provided by the scenario manager 102. In one example, scenario manager 102 besides, considering terrain avoidance in generating the valid insight options, also determines traffic in generating the list of valid off-set travel paths. Examples of a vehicle system to detect traffic that may be used by scenario manager 102 includes a traffic alert and collision avoidance system, a surveillance system and a radar system.

FIG. 7F illustrates an example of a fifth terrain strategy 750 relating to terrain avoidance that includes a request for a route to avoid terrain 736. The strategy directs the external data source 108 to use the resources of the external data source 108 to select the best travel path to avoid terrain from the list of valid off-set travel paths provided by the scenario manager 102. This strategy may be used when it is desired to use additional resources from the external data source in selecting a valid insight option.

FIG. 7G illustrates an example of a sixth terrain strategy 760 relating to terrain avoidance that includes a request for a shortest route 738. The strategy directs the external data source 108 to use the resources of the external data source 108 to select a travel path of the off-set travel paths provided by the scenario manager 102 as the shortest route. The scenario manager 102 may include a location of the vehicle with current vehicle parameters provided to the external data source 108.

The strategy may include the consideration of several strategies as illustrated in the seventh terrain strategy 770 of FIG. 7H. In this example, the strategies provided to the external data source 108 include the route of least fuel consumption 712, the route that avoids weather 722, the quickest completion route 732, the route to avoid traffic 734, the route to avoid terrain 736, and the shortest route 738. The external data source 108 is directed to select a valid offset travel path from the list of valid insight options using the strategy. Further, just as described above regarding the traffic strategies, the strategies to avoid terrain may include a strategy request to provide a ranked list from the valid insight options (the off-set travel paths in this example). Also, the strategies may include a strategy request to provide a number of best valid insight options. Further, the strategies may include a strategy to assign weighted values to different strategies.

Other examples of desiring a new off-set travel path includes situations where a new off-set travel path is desired for safety reasons. For example, in an avionic example, if traversing across a large body of water such as an ocean, it may be desirable to select a travel path that passes near land masses with airports. In another example, there may be regions that lack communication coverage. It may be desired to avoid those regions if possible.

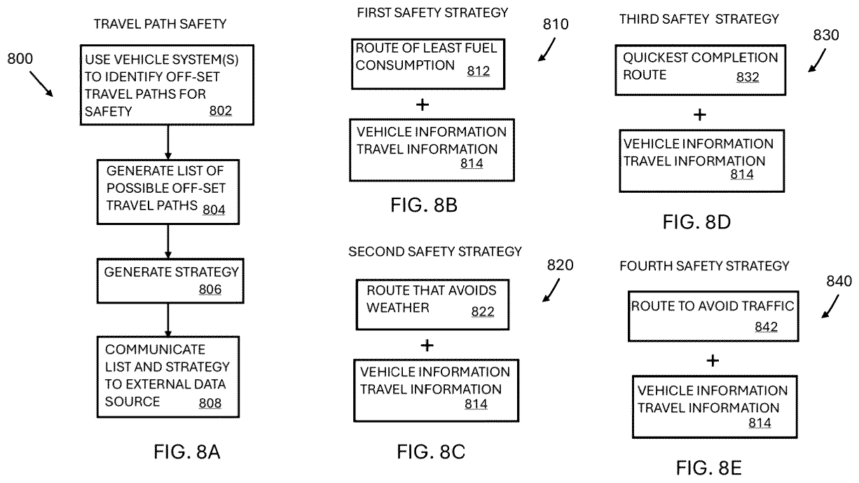

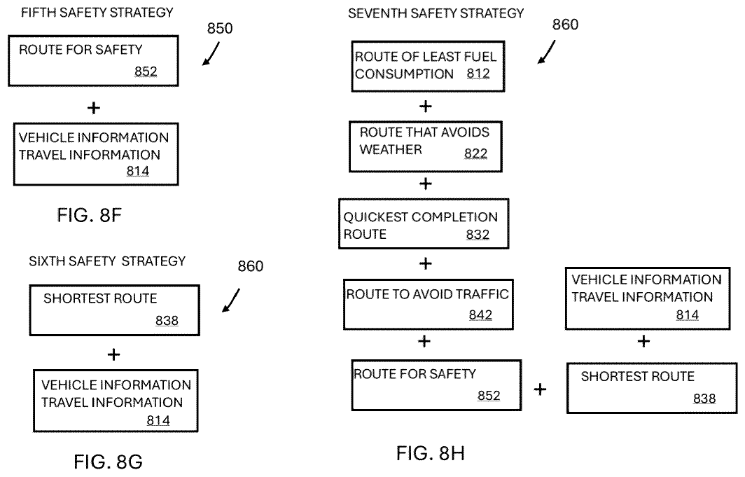

A method to mitigate safety concerns is provided in flow diagram 800 of FIG. 8A. Flow diagram 800 is provided as a sequence of blocks. The sequence of blocks may occur in a different order or in parallel in other embodiments. Hence, the present invention is not limited to sequential sequence set out in FIG. 8A.

Flow diagram 800 begins at block 802, using vehicle systems to identify off-set travel paths to address safety concerns. The vehicle systems that may provide information to the scenario manager 102 in generating the list of valid insight options (valid off-set travel paths) include global positioning systems, inertial measurements system, a runway database, communication database etc. The scenario manager 102 generates a list of valid insight options (valid off-set travel paths) that may be used based on the information available through certified vehicle systems at block 804. The list may be based on travel paths near known land masses with airports or travel paths that avoid regions that have poor communication coverage.

At block 806, the scenario manager 102 generates a strategy to be sent to the external data source 108 along with the list of valid insight options. The strategy will include strategies the external data source 108 is to use in selecting one or more of the options from the list of valid insight options. The strategy may also include vehicle information and travel information. The list of valid insight options and strategy is provided to the external data source at block 808.

Examples of safety strategies are illustrated in FIGS. 8B through 8G. Each of the strategies discussed in FIGS. 8B through 8G also includes vehicle information and travel information 814. Other factors, besides travel path safety, may also be considered by the external data source 108 in selecting one or more valid insight options from the list of valid insight options using the strategy provided with the list of valid insight options.

In FIG. 8B an example of a first safety strategy 810 includes a terrain avoidance strategy with a strategy of a route of least fuel consumption 812. External data source 108 may use the operating parameters of the vehicle in selecting one of the valid insight options from the list of valid insight options. Examples of parameters may include performance information, such as a maximum altitude, maximum speed, stall speed, etc., from a performance database. The first terrain strategy 810 provides the external data source 108 directions to select a travel path from among the list of off-set travel paths based on the strategy. The strategy directs the external data source 108 to select the best travel path that provides the least fuel consumption among the valid insight options (provided list of possible valid off-set travel paths). This may be used in a situation where the current amount of fuel in the vehicle is limited so the conservation of fuel is paramount in completing a vehicle's mission (i.e., reaching a designated runway in an avionic example). In another example, scenario manager 102, besides considering terrain avoidance, may also consider fuel consumption information from vehicle systems in generating the list of possible valid off-set travel paths. In an aircraft example, this may be done with a flight management system.

FIG. 8C illustrates an example of a second safety strategy 820 that directs the external data source 108 to use the strategy of selecting a route that avoids weather 822. The strategy directs the external data source 108 to select the best travel path that provides avoids undesirable weather among the valid insight options (provided list of possible valid off-set travel paths). This strategy may be used when the potential of undesirable weather is present that could be encountered in one or more the valid off-set travel paths. In one example, scenario manager 102 in generating the valid off-set travel paths, also considers weather information from available vehicle systems. In this example, the scenario manager 102, may look at available resources within systems of the vehicle, including an aircraft weather radar as well as from other certified sources in generating the list of verified insight options

FIG. 8D illustrates an example of a third safety strategy 830 relating to a quickest completion route 832. The strategy directs the external data source 108 to select the best travel path for completing the vehicles mission in the shortest time from the provided list of possible valid off-set travel paths. This strategy may be used when it is desired to reach the end of a mission as fast as possible (i.e., in an aircraft application when the aircraft is behind schedule). In one example, scenario manager 102 besides considering safety issues in generating the valid insight options, also determines off-set travel paths with quickest completion times for the list of valid insight options. The scenario manager 102, in this example, may look at available travel route processing applications within systems of the vehicle. One example system is a flight management system.

FIG. 8E illustrates an example of a fourth safety strategy 840 relating to safety that includes a request for a route to avoid traffic 842. The strategy directs the external data source 108 to use the resources of the external data source 108 to select the best travel path for safety from the list of valid off-set travel paths provided by the scenario manager 102. In one example, scenario manager 102 besides considering safety issues in generating the valid insight options, also determines traffic in generating the list of valid off-set travel paths. Examples of a vehicle system to detect traffic that may be used by scenario manager 102 includes a traffic alert and collision avoidance system, a surveillance system and a radar system.

FIG. 8F illustrates an example of a fifth safety strategy 850 that also relates to safety issues that includes a request for a route for safety 852. The strategy directs the external data source 108 to use the resources of the external data source 108 to select the best travel path to address the safety issues like passing near airports and avoiding regions with poor communications from the list of valid off-set travel paths provided by the scenario manager 102. This strategy may be used when it is desired to use additional resources from the external data source in selecting a valid insight option.

FIG. 8G illustrates an example of a sixth safety strategy 860 relating to safety issues that includes a request for a shortest route 838. The strategy directs the external data source 108 to use the resources of the external data source 108 to select a travel path of the valid off-set travel paths provided by the scenario manager 102 as the shortest route. The scenario manager 102 may include a location of the vehicle with current vehicle parameters provided to the external data source 108.

The strategy may include the consideration of several strategies as illustrated in the seventh safety strategy 860 of FIG. 8H. In this example, the strategies provided to the external data source 108 include the route of least fuel consumption 812, the route that avoids weather 822, the quickest completion route 832, the route to avoid traffic 842, the route for safety 852, and the shortest route 838. The external data source 108 is directed to select a valid offset travel path from the list of valid insight options using the strategy. Further, just as described above regarding the traffic strategies, the strategies for safety reasons may include a strategy request to provide a ranked list from the valid insight options (the off-set travel paths in this example). Also, the strategy may include a request to provide a number of best valid insight options. Further, the strategy may include a strategy to assign weighted values to different strategies.

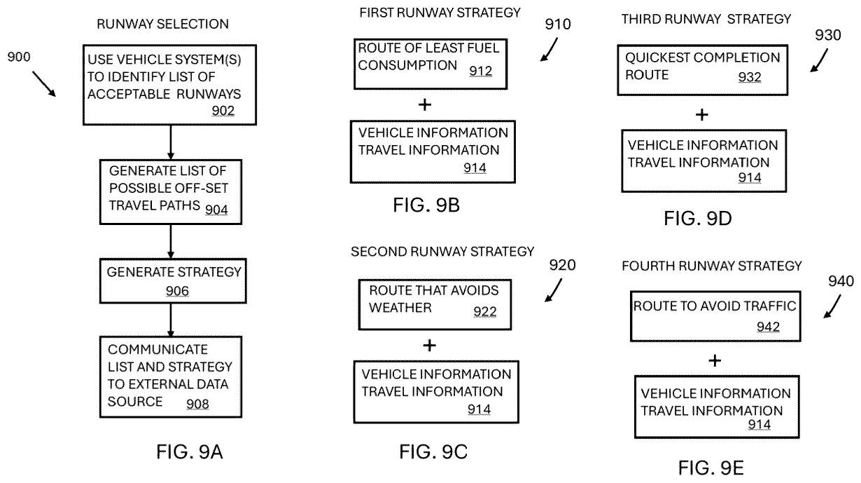

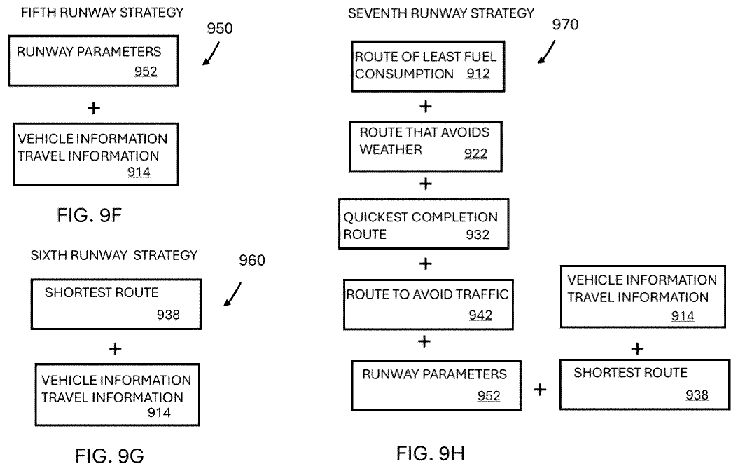

An example of a non-travel path list of valid insight options is when selecting a runway when a plurality of runways are available in an avionic example. This situation may occur when there is an urgency to land an aircraft. A method of selecting a runway, which may occur in an emergency situation, is provided in flow diagram 900 of FIG. 9A. Flow diagram 900 is provided as a sequence of blocks. The sequence of blocks may occur in a different order or in parallel in other embodiments. Hence, the present invention is not limited to sequential sequence set out in FIG. 9A.

Flow diagram 900 begins at block 902, using vehicle systems to identify acceptable runways. The vehicle systems that may provide information to the scenario manager 102 in generating the list of valid insight options (valid runways) include global positioning systems, inertial measurements system, a runway database, etc. The scenario manager 102 generates a list of valid insight options (valid runways in this example) that may be used based on the information available through certified vehicle systems at block 904. The list may be based on runways that can accommodate the aircraft based on the aircraft's parameters and which are in close proximity of the current location of the aircraft.

At block 906, the scenario manager 102 generates a strategy to be sent to the external data source 108 along with the list of valid insight options. The strategy will include instructions the external data source 108 is to use in selecting one or more of the options from the list of valid insight options. The strategy may include vehicle information and travel information. The list of valid insight options and strategy are provided to the external data source at block 908.

Examples of safety strategies are illustrated in FIGS. 9B through 9H. Each of the strategies discussed in FIGS. 9B through 9H also includes vehicle information and travel information 914. External data source 108 may use the operating parameters of the vehicle from the vehicle information in selecting one of the valid insight options from the list of valid insight options. Examples of parameters may include performance information, such as a maximum altitude, maximum speed, stall speed, etc., from a performance database.

In FIG. 9B an example of a first runway strategy 910 includes a strategy of a route of least fuel consumption 912. This strategy may be helpful during an emergency relating to fuel availability. Additional help from the external data source 108 may be needed to conserve the fuel in reaching a selected runway.

FIG. 9C illustrates an example of a second runway strategy 920 that directs the external data source 108 to use the strategy of selecting a route that avoids weather 922. The strategy directs the external data source 108 to select a runway which travel path avoids undesirable weather among the valid insight options (provided list of possible runways). This strategy may be used when the potential of undesired weather is present that could be encountered in one or more paths to the runways in the list of valid insight options. In one example, scenario manager 102 in generating the valid runways, also considers weather information from available vehicle systems. In this example, the scenario manager 102, may look at available resources within systems of the vehicle, including an aircraft weather radar as well as from other certified sources in generating the list of verified insight options

FIG. 9D illustrates an example of a third runway strategy 930 relating to a quickest completion route 932. The strategy directs the external data source 108 to select the runway that will take the shortest time to reach from the provided list of possible valid runways. This strategy may be used when it is desired to reach a runway as fast as possible (i.e., during an emergency situation). In one example, scenario manager 102 also determines runways which will be the closest to reach in generation the list of valid insight options provided to the scenario manager 102. The scenario manager 102, in this example, may look at available travel route processing applications within systems of the vehicle and available runway databases.

FIG. 9E illustrates an example of a fourth runway strategy 940 relating to a route to avoid traffic 942. The strategy directs the external data source 108 to use the resources of the external data source 108 to select the runway that provides a travel path that avoid traffic from the list of valid runways provided by the scenario manager 102. In one example, scenario manager 102 besides considering closeness of runways in generating the valid insight options, also determines traffic in generating the list of valid runways. Examples of a vehicle system to detect traffic that may be used by scenario manager 102 includes a traffic alert and collision avoidance system, a surveillance system and a radar system.

FIG. 9F illustrates an example of a fifth runway strategy 950 relating to runway parameters 952. The strategy directs the external data source 108 to use resources of the external data source 108 to select the best runway using the runway parameters and the vehicle operating parameters from the list of runways provided by the scenario manager 102. This strategy may be used when it is desired to use additional resources from external data source 108 in selecting a valid insight option (i.e., a runway that can accommodate the aircraft).

FIG. 9G illustrates an example of a sixth runway strategy 960 relating to runway selection that includes a request for a shortest route 938. The strategy directs the external data source 108 to use the resources of the external data source 108 to select a travel path of the off-set travel paths provided by the scenario manager 102 that has the shortest route. The scenario manager 102 may include a location of the vehicle with current vehicle parameters provided to the external data source 108.

The strategy may include the consideration of several strategies as illustrated in the seventh safety strategy 970 of FIG. 9H. In this example, the strategies provided to the external data source 108 include the route of least fuel consumption 912, the route that avoids weather 922, the quickest completion route 932, the route to avoid traffic 942, runway parameters 952, and shortest route 938. The external data source 108 is directed to select a valid offset travel path from the list of valid insight options using the strategy. Further, just as described above regarding the traffic strategies, the strategies to select a runway may include a strategy request to provide a ranked list from the valid insight options (the runway options in this example). Also, the strategies may include a strategy request to provide a number of best valid insight options.

### EXAMPLE EMBODIMENTS

Example 1 includes a system to mitigate effects of faulty external data provided to vehicle applications of vehicle systems. The system includes a plurality of vehicle systems and a scenario manager. The plurality of vehicle systems includes a plurality of vehicle applications. The plurality of vehicle applications are configured to at least in part control operations of a vehicle. The scenario manager includes a memory and a processor. The memory stores operating instructions and at least one database. The at least one database includes at least vehicle information. The processor is configured to implement the operating instruction stored in the memory. The processor is in communication with at least one external data source and the plurality of vehicle applications of the plurality of the vehicle systems. The processor is configured to generate a list of valid insight options based at least in part on at least one of the vehicle information and travel information. The processor is configured to communicate a strategy and the list of valid insight options to the external data source. The processor further configured to forward on one of the valid insight options selected from the list of valid insight options by the external data source to at least one vehicle application of the plurality of vehicle applications of the plurality of vehicle systems.

Example 2 includes the system of Example 1, wherein the strategy is one of fuel efficiency, shortest time of travel, shortest distance of travel, avoid weather, avoid traffic, avoid terrain, saftest route, runway parameters.

Example 3 includes the system of any of the Examples 1-2, wherein the strategy includes one of using a best system in selecting an option from the list of insight options, using a weighted system in selecting at least one option of the valid insight options, using a ranking system that ranks the valid insight options, and using a best select number of valid insight option system.

Example 4 includes the system of Example 3, wherein the plurality of vehicle systems includes at least one of a flight management system (FMS), an enhanced ground proximity warning system (EGPWS), communication, navigation, and a surveillance system.

Example 5 includes the system of any of the Examples 1-4, wherein the scenario manager is in communication with the external data source through a connected channel.

Example 6 includes the system of any of the Examples 1-5, further including a gateway configured to provide an interface for communication between the scenario manager and the external data source that includes the at least one application.

Example 7 includes the system of Example 6, wherein the external device wherein the external source is one of an electronic flight bag, an installed non-certified open world computer in a flight deck, and a communication interface to a cloud application.

Example 8 includes the system of any Examples 1-7, further including an input/output configured to convey the valid insight options to a vehicle operator.

Example 9 includes the system of Example 8, wherein the input/output provides the vehicle operator with an input to communicate with the scenario manager.

Example 10 includes the system of any of the Examples 8-9, wherein the scenario manager is configured to cause the input/output to display at least one valid insight option selected.

Example 11 includes the system of any of the Examples 1-10, wherein the scenario manager is in communication with an avionic bus to receive current aircraft state information.

Example 12 includes a system to mitigate effects of faulty external data provided to vehicle applications of vehicle systems. The system includes a plurality of vehicle systems, a scenario manager and a gateway. The plurality of vehicle systems including a plurality of vehicle applications, the plurality of vehicle applications configured to at least in part control operations of a vehicle. The scenario manager includes a memory to store operating instructions and at least one database. The at least one database, the at least one database including at least one of vehicle information and the travel information. The processor is in communication with at least one external application of an external device and the plurality of vehicle applications of the vehicle. The processor further in communication with a bus to receive current vehicle state information. The processor is configured to generate a list of valid insight options based at least in part on at least one of the vehicle information and travel information. The processor is configured to communicate a strategy and the list of valid insight options to at least one external application of an external device. The processor is further configured to forward on one of the valid insight options selected from the list of valid insight options by the external application to at least one vehicle application of the plurality of vehicle applications of the plurality of vehicle systems. The gateway is used to interface communications between the scenario manager and the external device.

Example 13 includes the system of Example 12, wherein the bus is an avionic bus and the received current vehicle state information is current aircraft state information.

Example 14 includes the system of any of the Examples 12-13, wherein the strategy is one of fuel efficiency during travel, shortest time of travel, and shortest distance of travel.

Example 15 includes the system of any of the Examples 12-14, wherein the external device is an electronic flight bag.

Example 16 includes a method of mitigating effects of faulty external data provided to vehicle applications of vehicle systems. The method includes generating at least one list of valid insight options; communicating a strategy and the at least one list of valid insight options to an external device, the external device configured to select at least one valid insight option of the at least one list; and forwarding the selected at least one valid insight option to at least one vehicle application of the vehicle systems for implementation.

Example 17 includes the method of Example 16, wherein generating the at least one list of insight options further includes using at least one of a vehicle information and travel information in generating the at least one list of insight options.

Example 18 includes the method of any of the Examples 16-17, further including generating the strategy based at least in part on at least one of fuel efficiency, shortest time of travel, shortest distance of travel, avoid weather, avoid traffic, avoid terrain, saftest route, runway parameters.

Example 19 includes the method of any of the Examples 16-18, further including allowing an operator of the vehicle to approve forwarding the selected at least one valid insight option to the at least one vehicle application of the vehicle systems.

Example 20 includes the method of any Examples 16-19, further including interfacing communications between a scenario manager that generated the at least one list of valid insight options and the external device.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A system to mitigate effects of faulty external data provided to vehicle applications of vehicle systems, the system comprising:
a plurality of vehicle systems including a plurality of vehicle applications, the plurality of vehicle applications configured to at least in part control operations of a vehicle; and
a scenario manager including,
a memory to store operating instructions and at least one database, the at least one database including at least vehicle information, and
a processor configured to implement the operating instruction stored in the memory, the processor in communication with an external data source and the plurality of vehicle applications of the plurality of the vehicle systems, the processor configured to generate a list of valid insight options based at least in part on at least one of the vehicle information and travel information, the processor configured to communicate a strategy and the list of valid insight options to the external data source, the processor further configured to forward on at least one of the valid insight options selected from the list of valid insight options by the external data source to at least one vehicle application of the plurality of vehicle applications of the plurality of vehicle systems.

2. The system of claim 1, wherein the strategy is one of fuel efficiency, shortest time of travel, shortest distance of travel, avoid weather, avoid traffic, avoid terrain, saftest route, runway parameters.

3. The system of claim 1, wherein the strategy includes one of using, a best system in selecting an option from the list of insight options, a weighted system in selecting at least one option of the valid insight options, a ranking system that ranks the valid insight options, and a best select number of valid insight option system.

4. The system of claim 3, wherein the plurality of vehicle systems includes at least one of a flight management system (FMS), an enhanced ground proximity warning system (EGPWS), communication, navigation, and a surveillance system.

5. The system of claim 1, wherein the scenario manager is in communication with the external data source through a connected channel.

6. The system of claim 1, further comprising:
a gateway configured to provide an interface for communication between the scenario manager and the external data source that includes the at least one application.

7. The system of claim 6, wherein the external source is one of an electronic flight bag, an installed non-certified open world computer in a flight deck, and a communication interface to a cloud application.

8. The system of claim 1, further comprising:
an input/output configured to convey insight options to a vehicle operator.

9. The system of claim 8, wherein the input/output provides the vehicle operator with an input to communicate with the scenario manager.

10. The system of claim 8, wherein the scenario manager is configured to cause the input/output to display at least one valid insight option selected.

11. The system of claim 1, wherein the scenario manager is in communication with an avionic bus to receive current aircraft state information.

12. A system to mitigate effects of faulty external data provided to vehicle applications of vehicle systems, the system comprising:
a plurality of vehicle systems including a plurality of vehicle applications, the plurality of vehicle applications configured to at least in part control operations of a vehicle;
a scenario manager including,
a memory to store operating instructions and at least one database, the at least one database including at least one of vehicle information and travel information, and
a processor configured to implement the operating instruction stored in the memory, the processor in communication with an external data source and the plurality of vehicle applications of the vehicle systems, the processor further in communication with a bus to receive current vehicle state information, the processor configured to generate a list of valid insight options based at least in part on at least one of the vehicle information and the travel information, the processor configured to communicate a strategy and the list of valid insight options to at least one external application of an external device, the processor further configured to forward on one of the valid insight options selected from the list of valid insight options by the external application to at least one vehicle application of the plurality of vehicle applications of the plurality of vehicle systems; and
a gateway to interface communications between the scenario manager and the external device.

13. The system of claim 12, wherein the bus is an avionic bus and the received current vehicle state information is current aircraft state information.

14. The system of claim 12, wherein the strategy includes at least one of one of fuel efficiency, shortest time of travel, shortest distance of travel, avoid weather, avoid traffic, avoid terrain, saftest route, runway parameters.

15. The system of claim 12, wherein the external device is an electronic flight bag.

16. A method of mitigating effects of faulty external data provided to vehicle applications of vehicle systems, the method comprising:
generating at least one list of valid insight options;
communicating a strategy and the at least one list of valid insight options to an external device, the external device configured to select at least one valid insight option of the at least one list; and
forwarding the selected at least one valid insight option to at least one vehicle application of the vehicle systems for implementation.

17. The method of claim 16, wherein generating the at least one list of insight options further comprises:
using at least one of a vehicle information and travel information in generating the at least one list of insight options.

18. The method of claim 16, further comprising:
generating the strategy based at least in part on at least one of fuel efficiency, shortest time of travel, shortest distance of travel, avoid weather, avoid traffic, avoid terrain, saftest route, runway parameters.

19. The method of claim 16, further comprising:
allowing an operator of the vehicle to approve forwarding the selected at least one valid insight option to the at least one vehicle application of the vehicle systems.

20. The method of claim 16, further comprising:
interfacing communications between a scenario manager that generated the at least one list of valid insight options and the external device.
